(19) United States
(12) Patent Application Publication
(10) Pub. No.: US 2020/0226584 A1
(43) Pub. Date: Jul. 16, 2020

(54) METHOD FOR MANAGING CAR WASH MEMBERSHIP PROGRAMS USING UNIQUE VEHICLE IDENTIFIERS FROM CONNECTED CARS

(71) Applicant: Alan John Nawoj, San Diego, CA (US)

(72) Inventor: Alan John Nawoj, San Diego, CA (US)

(21) Appl. No.: 16/708,098

(22) Filed: Dec. 9, 2019

Related U.S. Application Data
(60) Provisional application No. 62/777,248, filed on Dec. 10, 2018.

(51) Int. Cl. G06Q 20/32; B60S 3/04; B60S 3/00

(52) U.S. Cl. CPC G06Q 20/3278; B60S 3/04; G07C 5/008; G06Q 20/3274; B60S 3/004

(57) ABSTRACT

The present invention comprises a method of managing car wash membership programs that uses unique vehicle identifiers that can be read directly from a vehicle's onboard computer. This method works with vehicles that possess an onboard computer (i.e. “connected cars”) that collects data on the vehicle itself (e.g. vehicle identification number (VIN), oil life, fuel level) and exposes an interface that makes it possible for external systems to request and read this data. An example scenario utilizing this method involves a customer who installs a software application (app) for the car wash on their smartphone. The customer then selects their desired subscription car wash package within the app and the app initiates a communication link directly with the vehicle that will be associated with this membership account. Once the communication link is established between the smartphone app and the vehicle, a unique identifier will be requested from the vehicle's onboard computer, such as the VIN, and this vehicle identifier will be linked to the customer's membership account which is stored in an external system, typically in a cloud-based server and database. When the customer arrives at the car wash to request wash services under their membership, they will first use the smartphone app to “check in” to the car wash location by verifying that the vehicle associated with the customer's membership account is physically within a predefined distance of the car wash. The smartphone app may then establish a communication link with the vehicle to request its unique identifier and then pass this data to the external server and database to verify if the customer and vehicle are registered, active, and authorized to receive the requested service(s). If the request is deemed valid, then the smartphone app will provide a means of activating the requested car wash service(s), such as through a unique numeric code entered into the pay station kiosk, a barcode or QR code to be scanned and recognized by the pay station kiosk, a wireless signal sent directly or indirectly to the pay station kiosk or car wash controller for activation, or other equivalent methods. The service(s) rendered will then be logged and stored in the external system for future reference to ensure any limits on wash usage are not exceeded by the customer's account.

### FIELD OF THE INVENTION

The present invention relates to the process in which car washes manage customer membership programs. This includes both consumer car wash membership programs as well as corporate fleet car wash membership programs where the user of the car wash services may or may not be subject to usage limitations over a given time period. It also incorporates automotive Internet of Things (IoT) technology.

### BACKGROUND

Car washes typically consist of a physical structure or building with one or more bays or tunnels that contain specialized equipment for washing and drying cars, trucks, and other vehicles. Demand for professional car washing services has continued to increase due to the convenience, time savings, and eco-friendliness that these businesses offer versus washing your own vehicle at home. To capitalize on this growing demand, car wash owners often seek methods for converting one-time buyers of their services to recurring monthly subscribers due to the financial benefits of subscription-based income.

Presently, there are four main methods for managing subscription-based car wash membership programs and these include (1) adding radio frequency identifier (RFID) tags to identify member vehicles, (2) adding license plate scanner systems at the entrance of the wash to identify member vehicles, (3) using a smartphone app that members utilize onsite to authorize their wash, and (4) employing an attendant to stand at the entrance of the car wash to verify and authorize each member vehicle that arrives for a wash. The most common of these methods today and the de-facto industry standard for managing car wash membership programs is (1) the use of RFID tags. However, each of these methods listed has various shortcomings which end up resulting in inefficiencies and lost revenue for the car wash owner.

RFID tag-based car wash membership programs, for example, require the car wash owner to purchase and install individual RFID tags in each member's vehicle and then read those tags upon arrival to the wash with an RFID scanner that is linked to the wash equipment once the vehicle is within range. US Patent Application US20080277466A1 is an example of prior art regarding this method. The optimum placement for these tags is inside the vehicle on the front windshield. However, these tags can be carefully removed from a vehicle and passed around to non-members to take advantage of free car washes. Newer vehicles on the market also have special windshields with hidden films and other built-in components that interfere with the reading of the RFID tag upon arrival to the wash. As a result, many car washes that use RFID tag-based membership programs resort to attaching the RFID tag on the exterior of the vehicle so that it can be properly read, but this then exposes the tag to theft and damage from harsh weather or the car wash equipment itself. Furthermore, on busy days at a car wash where high throughput is critical, any issues with RFID tag scanning causes a ripple effect which slows down the entire line and therefore results in lost revenue to the car wash owner.

Car washes that utilize license plate scanning technology to identify member vehicles must deal with the limitation that license plate scanners are not 100% accurate. This is especially true in climates where snow and dirty roads can lead to obstructed license plates due to dirt and grime covering the plate number. Even with a clean license plate, a scanner may still identify the wrong number, for instance, if the plate itself is mangled, worn out, the sun's rays cause a reflection that interferes with the scanner, the difficultly of reading at nighttime, or a registration sticker directly touches the plate number causing a misread. Also, not all vehicles have a front license plate and it can be technically infeasible to position a license plate reader to read the back license plate considering the length of some vehicles and the limited real estate of most car wash sites. License plate scanners also tend to be very expensive to implement. US Patent U.S. Pat. No. 8,509,486B2 is an example of prior art regarding this method.

Some car washes utilize smartphone apps to facilitate purchasing and authorizing car wash services, including membership programs, by allowing the customer to purchase a wash or sign up for a membership program within the app and then authorize a wash based on some form of activation of either the car wash controller or pay station kiosk connected to the car wash controller. The downside, however, is that a member can easily share their app account login with non-members or simply pass their phone to a non-member to receive a free car wash. The issue is that the customer account is tied to a smartphone as opposed to a vehicle. US Patent U.S. Pat. No. 9,117,233B2 is an example of prior art regarding use of a smartphone for locating and activating car wash services in specific ways.

Finally, some car washes employ an individual who serves as a greeter or attendant at the car wash to identify and authorize car washes for paying members of one of their subscription programs. Unfortunately, this method is error-prone since the attendant can misread or inaccurately authorize vehicles due to the monotonous and labor intensive task of identifying and retrieving a customer profile for every vehicle that arrives on the car wash property. This method is also costly since it requires hiring a full-time employee or employees to serve as the verification and authorization checkpoint between a car wash member and its services. In such cases, the car wash is typically not able to operate 24 hours per day and 7 days per week, due to the fact that the cost of labor would be prohibitive.

Therefore, a need exists in the field for a cost-effective, easy to implement, reliable, and automated method for managing car wash membership programs that limits member washes per vehicle and prevents non-members from receiving free car wash services. This need coupled with the strong likelihood that connected cars will becomes more and more commonplace in the decades to come serves as a foundation for this invention. The term “connected car” can be used to characterize any vehicle that has built-in Internet access and an onboard computer that is capable of reading various sensors and data elements on the vehicle itself as well as interfacing with external systems.

### BRIEF SUMMARY OF THE INVENTION

The present invention comprises a method for managing car wash membership programs by leveraging connected car technologies. This method does not require any special hardware installations at the car wash like some methods described above (e.g. RFID tags, license plate scanners) nor does it allow non-members to obtain free car wash services by passing around an RFID tag or smartphone device or sharing account information of a paying member. The computer systems running on the customer's vehicle itself will be part of the car wash member authentication process for this invention. Two distinct embodiments exist for the implementation of this invention and these include (1) an application that runs on the customer's portable, Internet accessible electronic device, such as a smartphone, and (2) an application that runs directly on the vehicle's built-in computer and is visible on an electronic display inside the vehicle.

In either embodiment, the car wash membership customer will arrive at the car wash and first identify their presence at the site using some form of automated location sensing technology (e.g. GPS, Bluetooth, NFC, WiFi) that can be accessed from the application running on the customer's portable electronic device or vehicle. Once the vehicle's proximity to the car wash site is verified by this application and the application determines if the customer is a valid member by checking an external system, the application will then retrieve a unique identifier from the vehicle itself This unique identifier may include, but is not limited to, the Vehicle Identification Number (VIN) assigned to that vehicle by its manufacturer. If the unique vehicle identifier matches the one assigned to the customer's profile in the external system, then the car wash will be authorized through the application assuming the customer hasn't exceeded the usage limits defined by the car wash owner. For example, some car wash membership programs limit their members to a maximum of one car wash per day, and this check would be performed to determine if the customer is allowed to activate the wash on their current visit. If the application determines that the customer is authorized to receive a wash, it can either allow the customer to activate the car wash service (e.g. manual entry of a code into a pay station, scanning of a barcode or QR code, wireless signal to the pay station or car wash controller for activation) or an attendant employee can verify this authorization to allow the customer to proceed with their wash.

### BRIEF DESCRIPTION OF THE DRAWINGS

Some embodiments of the present invention are illustrated as an example and are not limited by the figures of the accompanying diagrams, in which like references may indicate similar elements and in which:

FIG. 1 illustrates an active car wash member using an application running on a portable, Internet accessible electronic device, such as a smartphone or tablet, which communicates with the vehicle's onboard computer, an external system that manages the car wash memberships, and a self-service pay station at the entrance of the car wash. Lines of communication are shown as dashed or dotted lines.

FIG. 2 illustrates an active car wash member using an application running on the vehicle's onboard computer with a display console and user interface inside the vehicle, an external system that manages the car wash memberships, and a self-service pay station at the entrance of the car wash. Lines of communication are shown as dashed or dotted lines.

FIG. 3 is a block diagram showing various actions or steps that are part of the process for carrying out this invention but are not necessarily performed sequentially or in the order shown.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly dictates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, this specification and claims should be read with the understanding that such combinations are entirely within the scope of the invention and the claims.

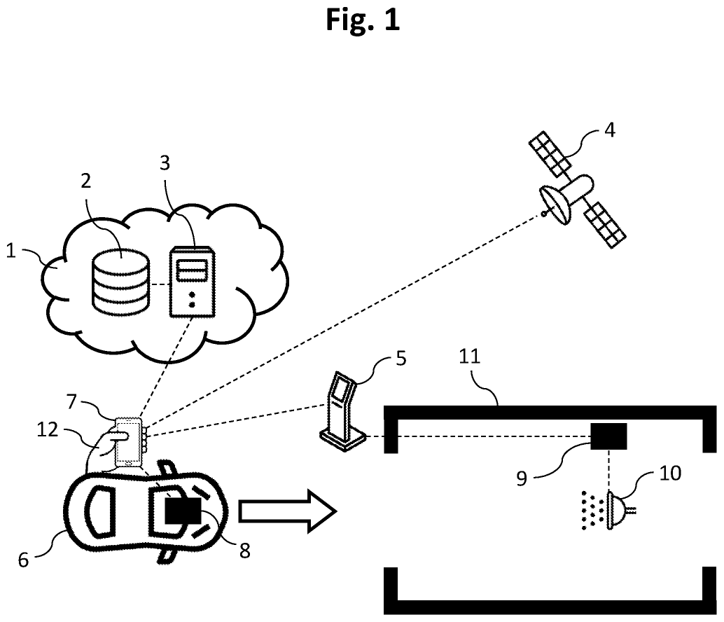

A method for managing car wash membership programs via connected cars is described herein. FIGS. 1-3 illustrate example car wash methods that allow a customer 12 to access car wash services as part of a subscription-based membership program using a connected car 6. A “connected car” is a term that is commonly applied to any vehicle with a built-in computer that collects data on the vehicle itself (e.g. fuel level, vehicle identification number, oil life) and provides a mechanism or interface for external systems to access this data, such as over an Internet connection, wired connection to the vehicle, or other short-range wireless connection (e.g. Bluetooth). Such a vehicle most likely has built-in Internet access, but this is not necessary for all embodiments of this invention since a smartphone or other portable electronic device can be used as a proxy for Internet access to an external cloud-based system where customer account and membership data are stored.

FIG. 1 illustrates an embodiment of this invention wherein a smartphone application (“app”) is used as the main controller in this process. An example of the method might proceed as follows. Customer 12 uses a smartphone app 7 to sign up for a subscription-based car wash membership program that is offered by the car wash with a physical location 11 and potentially other physical locations under the same brand. In order to complete the registration process, the customer may need to be inside or very close to the vehicle 6, which is characterized as a connected car, depending on the type of vehicle. The smartphone app 7 then establishes a connection to the connected car 6 which may require the customer 12 to allow permission for this connection to be established and/or log into their account with the vehicle's manufacturer. Once the connection between the smartphone app 7 is made with the connected car 6, the smartphone app will request a unique identifier from the vehicle, such as its vehicle identification number (VIN) or similar identifier. For reference, a VIN is a unique code that is used by the automotive industry to identify individual motor vehicles. This vehicle identifier will then be associated with the customer and transmitted by the smartphone app to a cloud-based server 3 and database 2. Herein, cloud 1 refers to the Internet or “cloud”, and the typical communication link between the smartphone app 7 and the cloud-based server 3 could be, but is not limited to, a Web service call, remote procedure call, or direct socket connection between the two endpoints of this link.

Now that customer 12 is a registered and paying member of a subscription car wash membership program for a given wash package and a specific vehicle 6, he or she arrives at the car wash facility 11 to initiate one of the car wash services. Before the car wash controller 9 can instruct the car wash equipment 10 to start cleaning the vehicle, the system first needs to verify multiple data points in this request. The customer 12 will tap a button, such as a “Check In” button, within the smartphone app 7 to first confirm that the vehicle's location is within a predefined distance of the car wash itself. This location check may involve a local Bluetooth or NFC connection or possibly the reception of GPS signals from GPS satellites 4 in orbit. If the location data indicates the vehicle is too far from the car wash, then the process will not proceed and an appropriate error message will be displayed to the customer.

If the location data request is validated by the smartphone app 7 as within range of the car wash location 11, then a subsequent step may involve the smartphone app 7 making a data connection to the connected car 6 that is being brought to the car wash. Establishment of this connection may first require the customer to grant the smartphone app 7 permission to connect to the vehicle's onboard computer 8, unless this permission was already saved. Once this connection is established, the smartphone app will request the vehicle's unique identifier, such as its VIN, unless this identifier was already used to query the location of the given vehicle. The smartphone app 7 will then issue a request to the cloud-based server 3 with data on the customer's account along with the vehicle's unique identifier. An application running on server 3 will then query information on this user and member account from database 2 and determine if the request can be honored. This determination may include checks, for instance, to validate that the vehicle identifier is the same one associated with the member's account, checks to see if the user has not exceeded any limits based on past car wash usage (e.g. limit of one member car wash per day), or checks to confirm the user is still an active, paying member.

The result of the server's validation process is then communicated back down to the smartphone app 7 where it is displayed to the customer 12. If the request was deemed invalid for any reason, then an appropriate error message will be displayed by the smartphone app 7 and the customer will not able to initiate a wash cycle. However, if the request was deemed valid, an appropriate mechanism will be triggered that enables the customer to initiate the requested wash cycle. This can include, for instance, displaying a unique numeric or alphanumeric code within the smartphone app that can be manually entered into the pay station kiosk 5 at the entrance to the car wash 11. Another option is the display of a barcode or QR code in the smartphone app that can be scanned and recognized by the pay station kiosk 5. Another option is a wireless communication that is initiated between the smartphone app 7 and the pay station kiosk 5 to either send a monetary balance to the kiosk or a signal that is passed along to the car wash controller unit 9 to activate the car wash machinery 10, which may include sprayers, brushes, water, soap, and wax dispensers, dryers, and the like. Alternatively, an employee or attendant may manually verify this result and initiate the car wash cycle for the customer on their own. The customer then proceeds with their car wash and the smartphone app 7 communicates data on the service that was just rendered back to the cloud-based server 3 for storage in the database 2 for future reference and audit purposes.

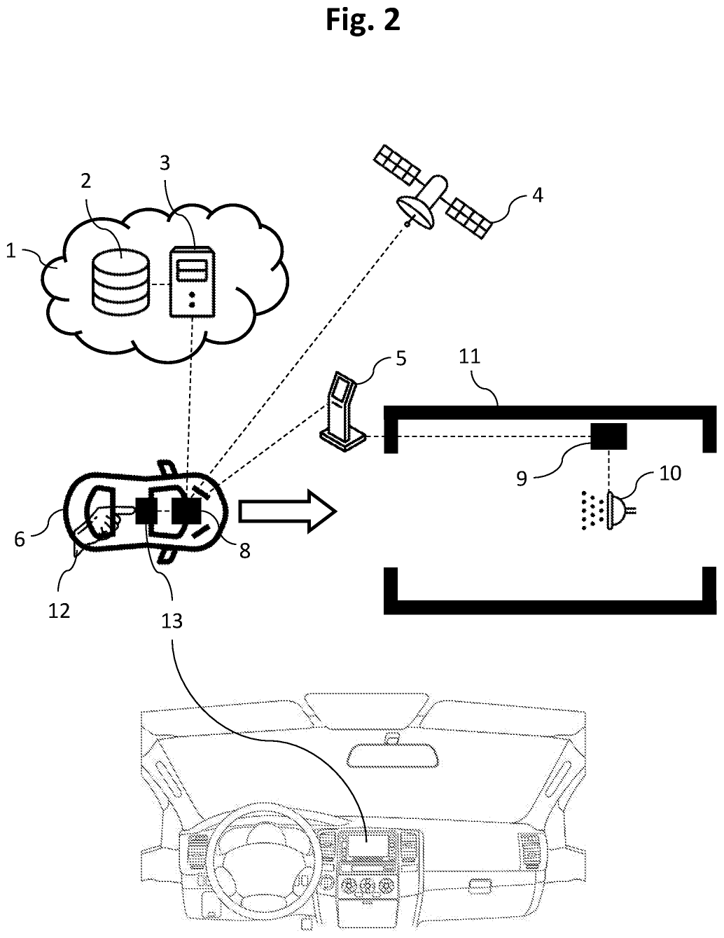

FIG. 2 illustrates an embodiment of this invention where an application running directly on the connected car's onboard computer system is used as the main controller in this process. This process is very similar to the process described in FIG. 1 except that the car wash application is running directly on the vehicle itself in lieu of a smartphone app. Since the vehicle has its own Internet connectivity, the in-vehicle car wash application running on the vehicle's computer 8 can communicate directly with the cloud-based server 3 to register the customer's membership account as well as validate any requests for car wash services. Similar to the FIG. 1 process where the customer arrives at the car wash location 11 and requests a car wash service as part of their subscription package, the FIG. 2 process involves doing a vehicle location or proximity check and a vehicle identifier check which gets transmitted to the cloud-based server 3 for verification. The results of this server-side verification are then returned directly to the vehicle's computer and displayed on an electronic display 13 within the vehicle, typically referred to as an infotainment display. If the request was successful, then the in-vehicle car wash application will initiate a wash cycle using one of, but not limited to, the methods described in paragraph 0022 above.

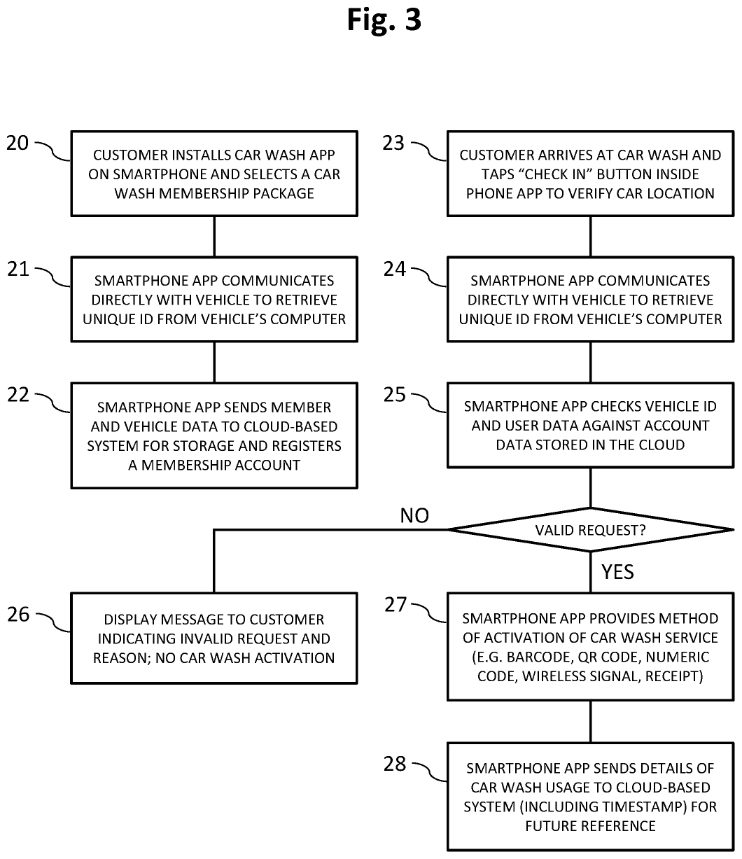

FIG. 3 illustrates an embodiment of this invention in terms of the overall method in which this car wash membership system is managed. There are two distinct processes that comprise this method and these include (1) the process in which the customer registers for their car wash subscription membership and (2) the process in which the customer arrives at the car wash to request washing services and the verifications that take place in order to authorize the request and initiate washing services, if successful.

Block 20 represents the first step in the registration process, wherein the customer 12 installs a smartphone application (“app”) 7 that is associated with the car wash brand that owns facility 11 onto their portable electronic device. This application may be a natively written application (e.g. iOS app for Apple Inc. devices, Android app for devices running Google Inc.'s Android operating system), Web application, or other custom piece of software that is capable of communicating with the vehicle and cloud-based servers. During this registration process, the customer will create an account on the application and select their desired car wash membership package. Typically, car washes offer multiple membership packages which differ based on price and the services included in the package. Block 21 represents the step in which the smartphone application 7 establishes a communication link with the vehicle's onboard computer 8. In order to establish this communication link, the user may need to grant permissions either by logging into an account on the vehicle that is managed by the vehicle manufacturer, accepting a permission request for data access, or some equivalent step. Once this communication link is established, the smartphone app 7 will request and obtain a key identifier for the vehicle (e.g. VIN or equivalent identifier). This key vehicle identifier will associate the vehicle in question with the car wash membership account that is being registered and prevent other vehicles from obtaining free car wash services under the registered account. Block 22 represents the final step of this registration process where the smartphone app 7 sends the vehicle identifier and other account data to a cloud-based server 3 where the account is registered and stored in a database 2 for future reference. During this process, the customer will also likely enter payment information (e.g. credit card, debit card, etc.) and agree to a recurring billing schedule and other terms and conditions based on the membership package selected.

Block 23 represents the first step in the process of authorizing a car wash member to receive services they are requesting under their membership. First off, the customer must verify the vehicle's proximity to the car wash site 11 by tapping a button either on their smartphone app 7 or on their in-vehicle app running on the vehicle's internal display 13. An example of the text on this button may be “Check In” or “Start Washing”. At this time, a location detection mechanism (e.g. GPS, Bluetooth, NFC, etc.) will be used to verify that the vehicle assigned to the customer's membership account is onsite at the car wash. If the vehicle is not close enough to the car wash based on a predefined distance, an appropriate error message will be communicated to the customer. If the location verification step succeeds, another potential step represented by block 24 is to verify that the vehicle being used is the same one that was registered under the customer's car wash membership account. This involves having either the smartphone app 7 request the vehicle's unique identifier (e.g. VIN) from the vehicle's onboard computer 8 or the in-vehicle car wash app requesting this information from the vehicle's onboard computer. Before this data can be requested from the vehicle's computer, the customer may need to grant permission to the application in question and/or log into their account with the vehicle's manufacturer. The order of the blocks represented in FIG. 3 may vary and in some cases certain steps may not be needed.

Block 25 represents the request verification step that takes place on a cloud-based server 3 and results either in a success or failure outcome. Either the smartphone app 7 or an in-vehicle app running on the vehicle's onboard computer 8 will send the vehicle identifier along with data on the customer (e.g. account identifier, car wash location) to a server 3 which runs a computer program to determine if the customer should be granted access to the car wash service(s) requested. This server-side computer program will retrieve data on the given account from a database 2 and confirm, for example, if the vehicle identifier and account information match what is stored in the database, if the account is currently valid or active, if the account hasn't exceeded any defined usage limits, and so forth.

If the request is deemed invalid, then block 26 represents the step wherein the smartphone app 7 or in-vehicle app running on the vehicle's onboard computer 8 receives this information from the server 3 and displays an appropriate error message to the customer on the relevant display. If the request is deemed valid, then block 27 represents the step in which the app provides the customer with a means of activating the car wash cycle. This may include, for instance, a unique numeric code that the customer enters into the pay station kiosk 5, a barcode or QR code that the customer scans on their smartphone at the pay station kiosk 5, a wireless signal that is transmitted either directly or indirectly from the smartphone app 7 or in-vehicle app to the pay station kiosk 5 or car wash controller 9. A car wash pay station kiosk 5 is a common device found at car wash facilities that enables a customer to pay for and select their desired wash services as well as activate the wash cycle without the need to interact with an employee. This kiosk typically interfaces with a car wash controller 9 which is the hardware unit that contains logic to control the activation, movement, sequencing, and so forth of the actual washing equipment, which may include sprayers, brushes, dryers, and the like. Another form of activation is for an employee or attendant at the car wash to verify the successful result on the customer's app and activate the car washing cycle on their own.

Finally, block 28 represents the step wherein the smartphone app 7 or in-vehicle app running on the vehicle's onboard computer 8 communicates the details of the rendered service(s) back to the cloud-based server 3 and database 2 to store for future reference. This record will contain a timestamp (e.g. date and time) and other relevant details of the wash services that were just rendered, such as the car wash location, the vehicle identifier, the customer's account identifier, the means of activation, the wash service identifier, and related information. Such data is not only used for auditing and tracking purposes by the car wash but is also referenced during future requests for car wash services by the same member account and vehicle to ensure that certain usage limits (if any) defined by the car wash owner are not exceeded.

What is claimed is:

1. A method of managing car wash membership programs using a unique vehicle identifier, such as a vehicle identification number (VIN), that is assigned to a customer member's account that can be retrieved by accessing the computer built into the vehicle (aka “connected car”). This method comprises:
Registering a car wash member's account in an Internet-accessible system;
Linking any vehicles assigned to the member's account using the unique identifier for each vehicle that is retrieved from the vehicle's onboard computer;
Verifying that the vehicle is physically onsite at the car wash location by confirming it is within a predefined distance of the car wash location;
Verifying that the customer is a registered car wash member based on the customer account data and the unique identifier for the vehicle that is retrieved from the vehicle's onboard computer and is authorized to receive the requested car wash services;

2. The method of claim 1, wherein the membership program is a consumer-facing membership program.

3. The method of claim 1, wherein the membership program is a business-facing membership program, also known as a fleet account or corporate account in the car wash industry.

4. The method of claim 1, wherein a portable electronic device with Internet access, such as a smartphone, that is running an application promoted by the car wash is used by the customer to both register as a car wash member and request car wash services upon arriving at a participating car wash site.

5. The method of claim 1, wherein a connected car (i.e. vehicle with an onboard computer that is capable of reading various sensors and data on the vehicle itself and interfacing with external systems through built-in Internet access or other methods of connectivity) that is running an application promoted by the car wash on its in-vehicle computer and display is used by the customer to register as a car wash member and request car wash services upon arriving at a participating car wash site.

6. The method of claim 1, wherein the means of activation of the requested car wash service(s) is through a unique numeric or alphanumeric code displayed to the customer either in the smartphone app, in-vehicle app, or equivalent program that can be entered into the car wash pay station kiosk.

7. The method of claim 1, wherein the means of activation of the requested car wash service(s) is through a unique barcode or QR code displayed to the customer in the smartphone app that can be scanned and recognized by the car wash pay station kiosk.

8. The method of claim 1, wherein the means of activation of the requested car wash service(s) is through a wireless signal that is transmitted either directly or indirectly from the smartphone app or in-vehicle app to the car wash pay station kiosk or car wash controller.

9. The method of claim 1, wherein the means of activation of the requested car wash service(s) is by having an onsite car wash employee or attendant verify the customer's request authorization and then manually initiates the selected service(s) for the customer.

10. The method of claim 6, wherein the unique numeric code, alphanumeric code, barcode, or QR code is buffered or stored by an external, Internet accessible system as opposed to generated on demand by the car wash pay station or car wash controller. Generating these codes beforehand in batch and then buffering or storing them in an external system that can be accessed via the customer's smartphone app or in-vehicle app over cellular data channels circumvents any potential onsite Internet issues which are common at many car washes.

11. The methods of claim 7, wherein the unique numeric code, alphanumeric code, barcode, or QR code is buffered or stored by an external, Internet accessible system as opposed to generated on demand by the car wash pay station or car wash controller. Generating these codes beforehand in batch and then buffering or storing them in an external system that can be accessed via the customer's smartphone app or in-vehicle app over cellular data channels circumvents any potential onsite Internet issues which are common at many car washes.
